(19) United States
(12) Patent Application Publication
(10) Pub. No.: US 2005/0049998 A1
(43) Pub. Date: Mar. 3, 2005

(54) Mechanism for deploying enterprise information system resources

(75) Inventors: Randy W. Ruhlow, Rochester, MN (US); Richard A. Saltness, Rochester, MN (US); John M. Santosuosso, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 10/651,175

(22) Filed: Aug. 28, 2003

(51) Int. Cl. G06F 7/00

(52) U.S. Cl. 707/1

(57) ABSTRACT

A method, apparatus and article of manufacture for data processing in data processing systems and, more particularly, for packaging and deploying enterprise information system resources using Java™ archive files. One embodiment for packaging enterprise information system resources using a Java™ archive file comprises bundling the enterprise information system resources, creating a deployment descriptor for the bundled enterprise information system resources, and packaging the bundled enterprise information system resources and the deployment descriptor into the Java™ archive file.

### BACKGROUND OF THE INVENTION

1. Field of the Invention

The present invention generally relates to data processing in data processing systems and more particularly to a mechanism for packaging and deploying enterprise information system resources.

2. Description of the Related Art

The creation of increasingly powerful computer (or computing) systems and a continuously improved information technology (IT) infrastructure contribute to a progressive automation of key tasks and processes in today's businesses. As a result, business processes, such as shipping, procurement and staffing, are transformed so as to be conducted electronically. Such electronically conducted business processes are referred to as electronic business (e-business). A generally accepted widely-used form of e-business is electronic commerce (e-commerce). E-commerce permits transactions for a variety of goods and services to be conducted electronically.

The widespread use and development of e-business come along with a development of business applications for interacting with numerous backend systems. Business applications are used to access and store information related to an e-business transaction. For example, a business application can be designed to provide for Web-based purchasing of goods or services. The backend systems are sometimes referred to as Enterprise (Enterprise is synonymous with legacy or data server) Information Systems (EISs). An EIS consists of applications that include an enterprise's existing system for handling company-wide information. These applications provide an information infrastructure for an enterprise. An EIS offers a well defined set of services to its clients. These services are exposed to clients as local and/or remote interfaces. Examples of EISs include core business applications, such as an ERP (Enterprise Resource Planning) and a mainframe transaction processing system, and a legacy database system.

A particular business application may need to interact with numerous EISs to ensure that a good or service purchased is delivered on time to the customer making the purchase. Such a transaction, while apparently simple, may involve interaction with numerous EISs related to parts procurement, receiving, manufacturing or Enterprise Resource Planning systems, shipping, accounting and many others. Many of these EISs are the result of several years of development and store vast amounts of data. These legacy EISs were often stand alone systems and not created to interact easily with other systems. Consequently, the development of a single business application which interacts with one or more EISs to provide for one or more e-business services is generally cumbersome and time-consuming.

A typical approach used to address the foregoing problems is to develop and deploy business applications using the Java™ 2 Platform, Enterprise Edition (J2EE) developed by Sun Microsystems. The J2EE specification provides a distributed services-based architecture for implementing secure, robust and interoperable business or enterprise applications. More specifically, J2EE is a platform-independent, Java-centric environment including a set of services, application programming interfaces and protocols that provide the functionality for developing, building and deploying multi-tiered Web-based and distributed enterprise applications on-line. For more background information regarding J2EE, readers are referred to the Sun Microsystems' publication, Designing Enterprise Applications with the Java™ 2 Platform, Enterprise Edition, by Nicholas Kassem, ISBN 0-20-1702770.

The J2EE technologies and specifications are supported by many computer and software vendors, such as International Business Machines (IBM), BEA and Oracle. These computer and software vendors provide J2EE products, i.e., they provide implementations that conform to the J2EE platform specification. The J2EE products are suitable to support J2EE applications implementing enterprise applications which are adapted to interact with EISs and, more specifically, with EIS resources. An EIS resource is a particular entity of an EIS, such as a database file or a core business application. For more detailed background information concerning the J2EE specifications, reference is made to Sun Microsystems' J2EE platform specification at “http://java.sun.com/j2ee”.

A J2EE application is any deployable application having J2EE functionality. A J2EE application consists of one or more J2EE modules and one J2EE application deployment descriptor. Three types of J2EE modules exist: EJB, Web, and application client. An application deployment descriptor contains a list of the application's modules and information on how to customize the application. The J2EE specification also provides mechanisms for packaging a J2EE application. Specifically, the J2EE application can be packaged as a Java ARchive (JAR) file with an “.ear” (Enterprise ARchive) extension. However, modules of the J2EE application can also be packaged separately. For instance, a Web module can be packaged as a JAR file with a “.war” (Web ARchive) extension and an EJB module can be packaged as a JAR file with a “.jar” extension. Moreover, an enterprise archive file with an “.ear” extension may contain such archive files having, for instance, “.jar” and “.war” extensions. In any case, J2EE provides platform-independent archive file formats suitable to aggregate many files into one for deployment. Corresponding platform-independent archive files, whether they have an “.ear”, “.jar”, “.war” or other extension, are all JAR files as they are all compressed using a JAR tool.

The J2EE specification also provides mechanisms for deploying the J2EE application. Accordingly, application servers that are J2EE compliant have built-in mechanisms to deploy J2EE applications. The packaging and deploying mechanisms are described in more detail in the above referenced J2EE specification.

However, excluded from the J2EE specification is packaging and deploying of EIS resources that the Java™ enterprise application depends on for backend processing. In other words, there is no mechanism provided that permits packaging the EIS resources within JAR files, such as .ear files, .jar files or .war files. Furthermore, there is no mechanism that allows for a deployment of these EIS resources from a source EIS to an appropriate destination EIS. More generally, there is no mechanism for packaging and deploying non-J2EE components in with a JAR file or other compressed file format.

Therefore, there is a need for a mechanism for packaging and deploying non-J2EE components using a JAR file.

### SUMMARY OF THE INVENTION

The present invention is generally directed to a method and article of manufacture for data processing in data processing systems and, more particularly, to a mechanism for packaging and deploying non-J2EE components, such as enterprise information system resources, using Java archive files or other compressed file formats.

One embodiment for packaging enterprise information system resources using a Java archive file comprises bundling the enterprise information system resources, creating a deployment descriptor for the bundled enterprise information system resources, and packaging the bundled enterprise information system resources and the deployment descriptor into the Java archive file.

Another embodiment comprises compressing the enterprise information system resources into one or more compressed files, determining deployment-related information describing at least the one or more compressed files, a deployment mechanism and a deployment destination indication, creating a deployment description file on the basis of the deployment-related information, packaging the one or more compressed files and the deployment description file into the Java archive file, and deploying the Java archive file using the deployment-related information.

Still another embodiment provides a method for packaging non-J2EE components using a J2EE-compliant file. The method comprises bundling the non-J2EE components, creating a deployment descriptor for the bundled non-J2EE components, and packaging the bundled non-J2EE components and the deployment descriptor into the J2EE-compliant file.

Still another embodiment provides a computer readable medium containing a program which, when executed, performs an operation for packaging enterprise information system resources using a Java archive file. The operation comprises bundling the enterprise information system resources, creating a deployment descriptor for the bundled enterprise information system resources, and packaging the bundled enterprise information system resources and the deployment descriptor into the Java archive file.

Still another embodiment provides a computer readable medium containing a program which, when executed, performs an operation for deploying enterprise information system resources using a Java archive file. The operation comprises compressing the enterprise information system resources into one or more compressed files, determining deployment-related information describing at least the one or more compressed files, a deployment mechanism and a deployment destination indication, creating a deployment description file on the basis of the deployment-related information, packaging the one or more compressed files and the deployment description file into the Java archive file, and deploying the Java archive file using the deployment-related information.

Still another embodiment provides a data structure residing in memory and comprising bundled enterprise information system resources and a deployment descriptor for the bundled enterprise information system resources.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an illustrative processing system.

FIG. 2 is a relational view illustrating the relationship between different components of the invention.

FIG. 3 is a data structure illustrating an enterprise information system resource deployment descriptor.

FIG. 4 is a flowchart illustrating one embodiment of a method performed by an enterprise information system resource manager according to the invention.

### DETAILED DESCRIPTION OF THE PREFERRED EMBODIMENTS

Introduction

The present invention is generally directed to data processing in data processing systems and, more particularly, to a mechanism for packaging and deploying non-J2EE components, such as EIS resources. The EIS resources, such as database files, core business applications and other enterprise resources are required for backend processing of a business application. According to one aspect of the invention, the EIS resources are required for backend processing of a Java™ enterprise application, i.e., a J2EE application. The J2EE application consists of one or more J2EE modules and one J2EE application deployment descriptor. The J2EE application can be packaged and deployed by means of a JAR file, or any other similar file which may be specified by a Java enterprise application and, at least in one embodiment, may be compressed.

In the context of the invention, the term “deploying” refers to making one or more software elements, such as the J2EE application, available on a destination system. Deploying may include transferring and/or installing the J2EE application to/on the destination system. The term “packaging” refers to grouping components or types of a software element or different software elements together for deployment. Packaging may include storing the one or more J2EE modules of the J2EE application in a common JAR file. The term “JAR file” refers to any compressed file that has been created using a JAR compression tool, e.g., an ear file, a .jar file or a .war file.

One embodiment provides an EIS resource manager which is configured for packaging and deploying the EIS resources using the JAR file. To this end, the EIS resource manager bundles the EIS resources and creates an EIS deployment descriptor for the bundled EIS resources. The EIS deployment descriptor identifies the EIS resources, where they are found, what mechanism is used to package and/or deploy them and to which EIS they will be deployed. The EIS resource manager packages the bundled EIS resources and the EIS deployment descriptor into the JAR file.

The JAR file can be deployed by any application server that is configured to deploy J2EE compliant applications (also referred to as a J2EE compliant application server). The application server is configured to read the EIS deployment descriptor and execute instructions defined therein for deployment of the bundled EIS resources.

In one embodiment, the JAR file containing the J2EE application is provided for packaging the bundled EIS resources and the EIS deployment descriptor. In another embodiment, a data structure, such as a JAR file, can be created for packaging the bundled EIS resources and the EIS deployment descriptor. Accordingly, the EIS resources can be packaged into a data structure separate from the J2EE application. This enables deploying the J2EE application and the EIS resources separately. In other words, the J2EE application and the EIS resources can be deployed to different destination systems.

Preferred Embodiments

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features and advantages are merely illustrative and, unless explicitly present, are not considered elements or limitations of the appended claims.

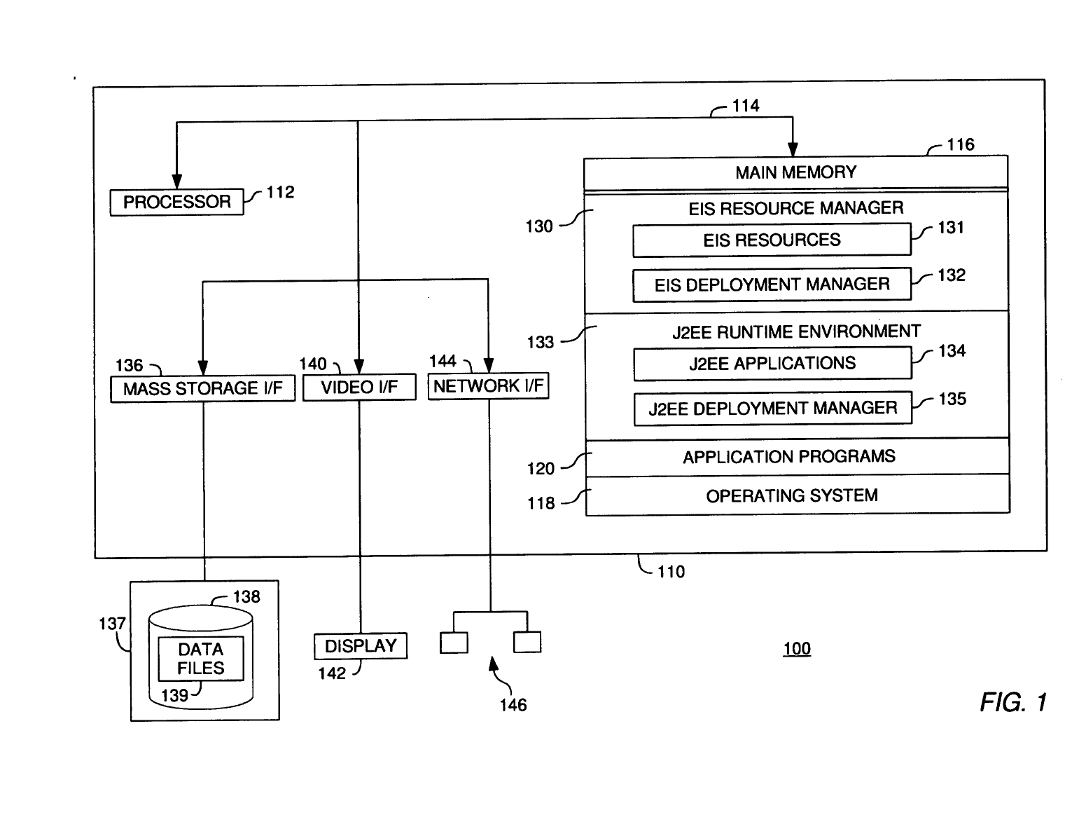

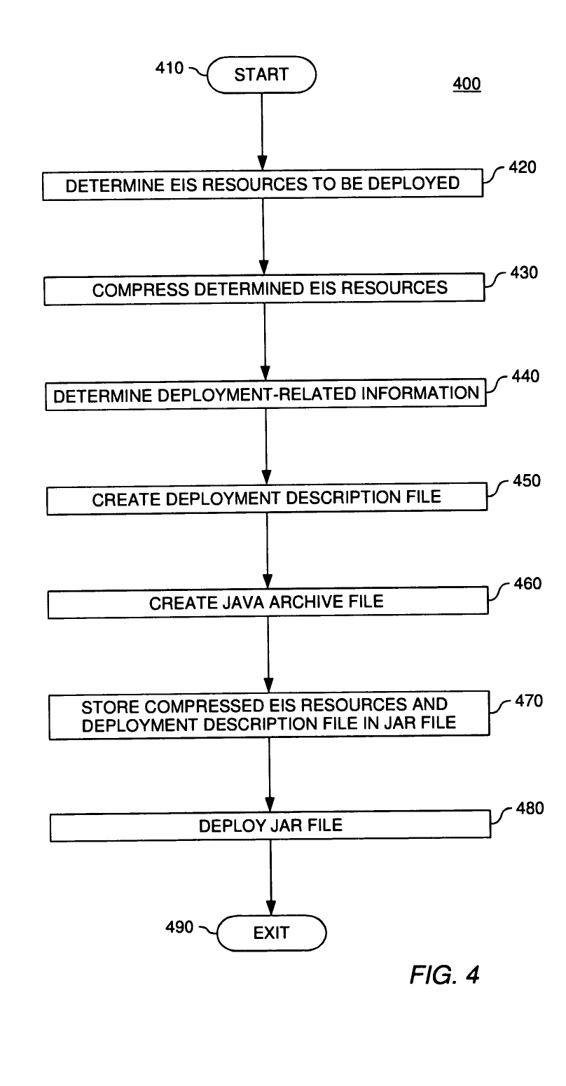

One embodiment of the invention is implemented as a program product for use with a computer system such as, for example, processing environment 100 shown in FIG. 1 and described below. The program(s) of the program product defines functions of the embodiments (including the method described below with reference to FIG. 4) and can be contained on a variety of signal/bearing media. Illustrative signal/bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program” or some other suitable nomenclature. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Some embodiments of the present invention are described in the context of databases. However, embodiments within the scope of the invention are applicable to any data processing system in which it is desirable to ensure the validity of data that is represented in a persistent form as well as in transient form (e.g., stored in cache or other temporary memory location). Further, while the following embodiments are described with reference to J2EE and, in particular, to J2EE applications, the present invention is not so limited.

Referring now to FIG. 1, a computing environment 100 is shown. In general, the distributed environment 100 includes a data processing system 110, interchangeably referred to as the computer system 110, and a plurality of networked devices 146. The computer system 110 may represent any type of computer, computer system or other programmable electronic device, including a client computer, a server computer, a portable computer, an embedded controller, a PC-based server, a minicomputer, a midrange computer, a mainframe computer, and other computers adapted to support the methods, apparatus, and article of manufacture of the invention. In one embodiment, the computer system 110 is an eServer iSeries 400 available from International Business Machines of Armonk, N.Y.

Illustratively, the computer system 110 comprises a networked system. However, the computer system 110 may also comprise a standalone device. In any case, it is understood that FIG. 1 is merely one possible configuration for a computer system. Embodiments of the invention can apply to any comparable configuration, regardless of whether the computer system 110 is a complicated multi-user apparatus, a single-user workstation, or a network appliance that does not have non-volatile storage of its own.

The embodiments of the present invention may also be practiced in distributed computing environments in which tasks are performed by remote processing devices that are linked through a communications network. In a distributed computing environment, program modules may be located in both local and remote memory storage devices. In this regard, the computer system 110 and/or one or more of the networked devices 146 may be thin clients which perform little or no processing.

The computer system 110 could include a number of operators and peripheral systems as shown, for example, by a mass storage interface 136 operably connected to a direct access storage device 137, by a video interface 140 operably connected to a display 142, and by a network interface 144 operably connected to the plurality of networked devices 146. The display 142 may be any video output device for outputting viewable information.

Computer system 110 is shown comprising at least one processor 112, which obtains instructions and data via a bus 114 from a main memory 116. The processor 112 could be any processor adapted to support the methods of the invention.

The main memory 116 is any memory sufficiently large to hold the necessary programs and data structures. Main memory 116 could be one or a combination of memory devices, including Random Access Memory (RAM), nonvolatile or backup memory, (e.g., programmable or Flash memories, read-only memories (ROM), etc.). In addition, memory 116 may be considered to include memory physically located elsewhere in the computer system 110 or in the computing environment 100, for example, any storage capacity used as virtual memory or stored on a mass storage device (e.g., direct access storage device 137) or on another computer coupled to the computer system 110 via bus 114.

The memory 116 is shown configured with an operating system 118. The operating system 118 is the software used for managing the operation of the computer system 110. Examples of the operating system 118 include IBM OS/400®, UNIX, Microsoft Windows®, and the like.

The memory 116 further includes one or more application programs 120, a J2EE runtime environment 133 and an EIS resource manager 130. Illustratively, the J2EE runtime environment 133 includes one or more J2EE applications 134 and a J2EE deployment manager 135. The EIS resource manager 130 illustratively includes one or more EIS resources 131 and an EIS deployment manager 132.

In one embodiment, the applications 120 depend on one or more databases 138 (for simplicity, only one database is shown) for backend processing. Backend processing may include issuing queries against the one or more databases 138. More specifically, backend processing may include issuing queries against one or more data files 139 stored in the database 138. Illustratively, the database 138 is stored in the direct access storage device 135. However, it should be appreciated that the database 138 can be stored in any other suitable storage means, including a remote storage device or the main memory 116. Further, although shown separately, the database 138 may also be part of the EIS resources 131. Alternatively, the EIS resources 131 can be stored in the database 138. Furthermore, the EIS resources 131 may include one or more of the applications 120 representing core business applications.

In one embodiment, one or more J2EE applications 134 are running in the J2EE runtime environment 133. Each J2EE application 134 may also depend on one or more of the data files 139 for backend processing. For instance, a J2EE application may depend on one or more data files 139 containing shipping and/or accounting information. Moreover, each J2EE application 134 may depend on one or more of the EIS resources 131, such as an ERP, for backend processing. For instance, a J2EE application may depend on one or more of the EIS resources 131 for managing parts procurement, receiving of orders and/or manufacturing. The J2EE applications 134 can be packaged and deployed using the J2EE deployment manager 135. The EIS resources 131 can be packaged and deployed using the EIS deployment manager 132.

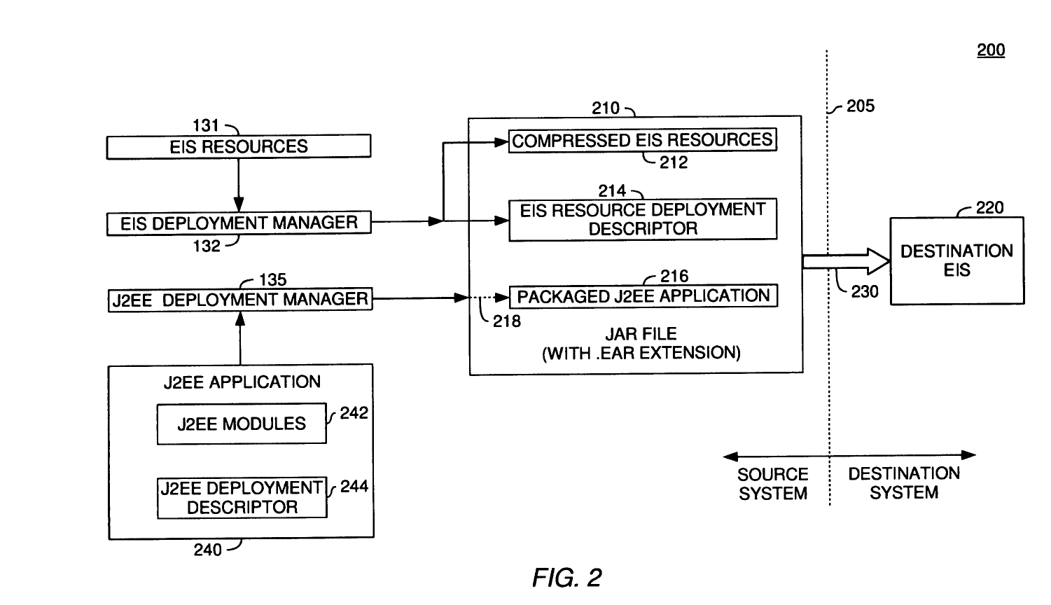

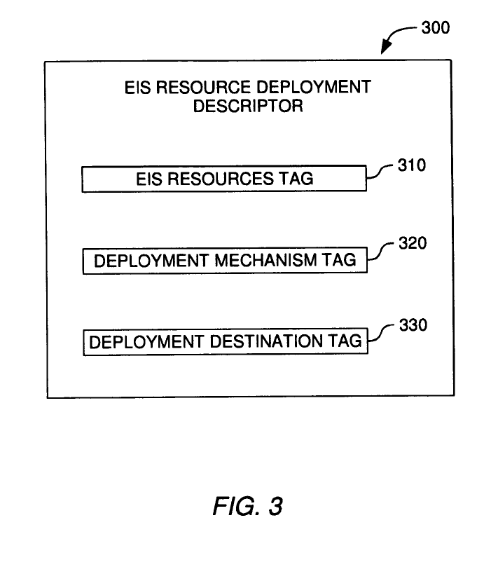

The J2EE runtime environment 133, the EIS resource manager 130 and the application programs 120 are software products comprising a plurality of instructions that are resident at various times in various memory and storage devices in the computing environment 100. When read and executed by one or more processors 112 in the computer system 110, the application programs 120, the J2EE runtime environment 133 and the EIS resource manager 130 cause the computer system 110 to perform the steps necessary to execute steps or elements embodying the various aspects of the invention. The J2EE runtime environment 133, the EIS resource manager 130 and their constituent functions are further described below with reference to FIGS. 2 and 3.

Referring now to FIG. 2, an illustrative relational view 200 of the components of the J2EE runtime environment 133 and the EIS resource manager 130, and other components of the invention is shown. As indicated by the dashed line 205, the relational view 200 illustrates interaction between components and functions of a source system (e.g., computer system 110) and a destination system (e.g., a networked device 146). More specifically, the relational view 200 illustrates operation of the J2EE deployment manager 135 and the EIS deployment manager 132 according to one aspect of the invention.

The J2EE deployment manager 135 and the EIS deployment manager 132 operate to package and deploy a J2EE application 240 (e.g., one of the J2EE applications 134 of FIG. 1) and the EIS resources 131, respectively. Illustratively, the J2EE application 240 and the EIS resources 131 are packaged and deployed using a common JAR file 210. By way of example, the JAR file 210 is deployed to one or more destination EISs 220, as indicated by arrow 230.

More specifically, the J2EE deployment manager 135 is configured for packaging and deploying the J2EE application 240. The J2EE application 240 includes one or more J2EE modules 242 and a corresponding J2EE application deployment descriptor 244 (also referred to as the J2EE deployment descriptor). The one or more J2EE modules 242 include, for instance, a web module and/or an EJB module. Accordingly, the J2EE deployment descriptor 244 includes a web module deployment descriptor and/or an EJB deployment descriptor. The J2EE deployment descriptor 244 contains information that describes how the J2EE application 240 should be deployed. However, J2EE applications, modules and deployment descriptors as well as packaging and deploying thereof are well-known in the art and will, therefore, not be explained in more detail.

The J2EE deployment manager 135 packages the J2EE application 240 as a packaged J2EE application 216 into the JAR file 210. The JAR file 210 is suffixed with an “.ear” extension. The J2EE deployment manager 135 creates the JAR file 210 when packaging the J2EE application 240. Accordingly, at that time, the JAR file 210 only contains the packaged J2EE application 216, as indicated by dashed arrow 218. Subsequently, the JAR file 210 is provided to the EIS deployment manager 132.

The EIS deployment manager 132 is configured for packaging and deploying the EIS resources 131. A corresponding method is illustrated below with reference to FIG. 4. The EIS deployment manager 132 bundles the EIS resources 131 in order to generate bundled EIS resources 212 which are suitable for packaging. In one embodiment, bundling includes compressing the EIS resources 131 into one or more compressed files. Furthermore, the EIS deployment manager 132 creates an EIS resource deployment descriptor 214 (interchangeably referred to as the deployment descriptor). The deployment descriptor 214 includes deployment-related information describing the bundled EIS resources 212, a deployment mechanism and a deployment destination (e.g., destination EIS 220). An embodiment of the deployment descriptor 214 is described in the following with reference to FIG. 3.

FIG. 3 illustrates an embodiment of an EIS resource deployment descriptor 300 (e.g., EIS resource deployment descriptor 214 of FIG. 2). The deployment descriptor 300 includes an EIS resources tag 310, a deployment mechanism tag 320 and a deployment destination tag 330.

The EIS resources tag 310 describes bundled EIS resources (e.g., bundled EIS resources 212 of FIG. 2), which are to be packaged and deployed. In one embodiment, the EIS resources tag 310 defines a name and a path of a file that contains the EIS resources. Thus, if more than one file is provided for the EIS resources, a separate deployment descriptor 300 is provided for each file. In one embodiment, each file that contains EIS resources is compressed. Each compressed file is, for instance, in one of the ZIP, JAR and SAVF file format.

The deployment mechanism tag 320 specifies at least one instruction that is suitable to cause execution of a function on a J2EE compliant application server (e.g., computer system 110 of FIG. 1). The function is configured for transferring/downloading and/or deploying the bundled EIS resources to a deployment destination. The instruction(s) specified by 320 includes, for instance, an FTP, EXTRACT, UNZIP and a STRQSH command. In one embodiment, the instruction(s) is an executable program module on the J2EE compliant application server, such as a “.bat”, “.exe” or “.class” file, that contains one or more of the above described commands.

The deployment destination tag 330 specifies one or more destination EISs (e.g., destination EIS 220 of FIG. 2) to which the bundled EIS resources should be deployed. In one embodiment, a destination EIS is identified by a name and an IP address. However, any identification of a destination EIS, such as for instance a Uniform Resource Locator (URL), is contemplated.

In one embodiment, the deployment descriptor 300 is implemented as a deployment description file using XML. The deployment description file is suffixed with an “.xrf” extension. The “.xrf” extension represents eXternal Resource File. The following table, Table 1, illustrates an exemplary deployment description file in the XML file format.

TABLE I
EXEMPLARY DEPLOYMENT DESCRIPTION FILE

| | | | | |
|---|---|---|---|---|
| 001 | <resourceFile | name= | path= | > |
| 002 | <system | name= | ip= | > |
| 003 | <exec | name= | | > |
| 004 | </resourceFile> | | | |

Illustratively, the exemplary deployment description file shown in Table 1 includes an EIS resources tag (line 001), a deployment destination tag (line 002) and a deployment mechanism tag (line 003) as described above.

Referring now back to FIG. 2, the EIS deployment manager 132 packages the bundled EIS resources 212 and the deployment descriptor 214 into the provided JAR file 210. The JAR file 210 is subsequently deployed to the destination EIS 220.

It should be appreciated, that the above description with reference to FIGS. 2 and 3 has merely been provided for purposes of illustration of the operation of the J2EE deployment manager 135 and the EIS deployment manager 132. However, various modifications are possible and will be readily understood by those skilled in the art. For instance, the J2EE application 240 and the EIS resources 131 can be packaged and deployed using separate JAR files. Thus, one JAR file can be provided for the EIS resources 131 and another JAR file can be provided for the J2EE application 240. Both JAR files can be deployed to one or more common destination EISs (e.g., 220). Alternatively, the JAR file having the EIS resources 131 and the JAR file having the J2EE application 240 can be deployed to different destination EISs. Furthermore, the EIS resources 131 can be bundled in multiple different ways. To this end, they may be compressed or not, depending on system requirements and/or based on user indications. Furthermore, various different implementations of the deployment descriptor 300 are possible. Thus, the illustration of the exemplary deployment description file in the XML file format is not intended to limit implementations of the deployment descriptor to this specific file format. Instead, any implementation of the deployment descriptor in any file format, known or unknown, is contemplated.

Referring now to FIG. 4, an embodiment of a method 400 for packaging and deploying EIS resources (e.g., EIS resources 131 of FIG. 1) is illustrated. The method 400 starts at step 410.

In step 420, EIS resources to be deployed are determined. For instance, a number of data files (e.g., data files 139 of FIG. 1) are determined which are required for backend processing of a J2EE application (e.g., J2EE application 240 of FIG. 2) to be deployed. In step 430, the determined EIS resources are bundled. In one embodiment, bundling includes compressing the determined EIS resources using a generally available compression tool, such as the Java™ Archive, WinZip or PKZip tool. Thus, the determined EIS resources may be compressed into one or more compressed files of available archive file types, such as the “.jar”, “.zip” or “.savf” file types.

In step 440, deployment-related information is determined. Accordingly, information describing the bundled EIS resources (e.g. bundled EIS resources 212 of FIG. 2), a deployment mechanism and a deployment destination (e.g., destination EIS 220 of FIG. 2) is determined. In step 450, the determined deployment-related information is used to create to a deployment descriptor (e.g., deployment descriptor 214 of FIG. 2). In one embodiment, creating the deployment descriptor includes creating a deployment description file, such as the exemplary deployment description file shown in Table 1.

In step 460, a JAR file is created for packaging and deploying the bundled EIS resources. In step 470, the bundled EIS resources and the deployment description file are packaged into the JAR file. Packaging the bundled EIS resources and the deployment description file into the JAR file includes, for instance, storing the EIS resources and the deployment description file into the JAR file.

In step 480, the JAR file is deployed to the deployment destination. Deploying the JAR file may include downloading the JAR file to the deployment destination. More specifically, in one embodiment, a J2EE compliant application server would extract the deployment description file from the JAR file. If the deployment description file is an “.xrf” file as illustrated above in Table I, the J2EE compliant application server would locate and identify each <resourceFile> tag (line 001 in Table I) therein. The J2EE compliant application server would determine the bundled EIS resources from the <resourceFile> tag (line 001 in Table I), the deployment destination from the <system> tag (line 002 in Table I) and the deployment mechanism from the <exec> tag (line 003 in Table I). Furthermore, the J2EE compliant application server would execute the instruction(s) identified by the deployment mechanism. The instruction(s), when executed, would cause execution of a function that will take the bundled EIS resources and the deployment destination as parameters to a corresponding execution call. The execution call deploys the bundled EIS resources to the deployment destination. The method 400 then exits at step 490.

It should be understood that the illustrated sequence of steps in the method 400 has merely been chosen for purposes of illustration. However, various modifications are possible. For instance, several of the illustrated steps may be interchanged, such as steps 430 and 440. Furthermore, several of the illustrated steps can be executed concurrently, such as steps 460 and 470. Thus, the method 400 is not limited to the illustrated sequence of steps and any possible sequence and combination of steps that is suitable for packaging and deploying EIS resources is contemplated.

While the foregoing is directed to embodiments of the present invention, other and further embodiments of the invention may be devised without departing from the basic scope thereof, and the scope thereof is determined by the claims that follow.

1. A method for deploying enterprise information system resources using a Java archive file, the method comprising:
bundling the enterprise information system resources;
creating a deployment descriptor for the bundled enterprise information system resources; and
packaging the bundled enterprise information system resources and the deployment descriptor into the Java archive file.

2. The method of claim 1, further comprising:
enabling at least one of downloading and deployment of the Java archive file.

3. The method of claim 1, wherein each enterprise information system resource is a platform-dependent non-J2EE component.

4. The method of claim 1, wherein each enterprise information system resource is at least one of a database file, a core business application and any combination thereof.

5. The method of claim 1, wherein the Java archive file is at least one of an enterprise archive file and a web archive file.

6. The method of claim 1, wherein bundling the enterprise information system resources comprises:
compressing the enterprise information system resources into one or more compressed files.

7. The method of claim 1, wherein the deployment descriptor comprises at least one of deployment-related information describing the bundled enterprise information system resources, a deployment mechanism, a deployment destination and any combination thereof.

8. The method of claim 7, wherein the deployment-related information describing the deployment mechanism specifies at least one instruction that is suitable to cause at least one of downloading and deploying the bundled enterprise information system resources.

9. The method of claim 1, wherein packaging the bundled enterprise information system resources and the deployment descriptor comprises:
creating the Java archive file; and
storing the bundled enterprise information system resources and the deployment descriptor to the created Java archive file.

10. A method for deploying enterprise information system resources using a Java archive file, the method comprising:
compressing the enterprise information system resources into one or more compressed files;
determining deployment-related information describing at least the one or more compressed files, a deployment mechanism and a deployment destination indication;
creating a deployment description file on the basis of the deployment-related information;
packaging the one or more compressed files and the deployment description file into the Java archive file; and
deploying the Java archive file using the deployment-related information.

11. The method of claim 10, wherein deploying the Java archive file comprises downloading the Java archive file.

12. The method of claim 10, wherein each enterprise information system resource is at least one of a database file, a core business application and any combination thereof.

13. The method of claim 10, wherein the Java archive file is an enterprise archive file or a web archive file.

14. The method of claim 10, wherein each compressed file is in one of the ZIP, JAR and SAVF file format.

15. The method of claim 10, wherein the deployment description file is an XML file.

16. The method of claim 10, wherein the deployment-related information describing the deploying mechanism specifies at least one instruction that is suitable to cause at least one of downloading and/or deploying the one or more compressed files, the at least one instruction being one of an FTP, EXTRACT, UNZIP and STRQSH command.

17. The method of claim 10, wherein packaging the one or more compressed files and the deployment description file comprises:
creating the Java archive file; and
storing the one or more compressed files and the deployment description file to the created Java archive file.

18. The method of claim 17, wherein storing the one or more compressed files and the deployment description file to the created Java archive file is performed using an application assembly tool or a J2EE integrated development environment.

19. A method for packaging non-J2EE components using a J2EE-compliant file, the method comprising:
bundling the non-J2EE components;
creating a deployment descriptor for the bundled non-J2EE components; and
packaging the bundled non-J2EE components and the deployment descriptor into the J2EE-compliant file.

20. The method of claim 19, wherein the non-J2EE components are platform-dependent components and the J2EE-compliant file is a platform-independent file.

21. The method of claim 19, wherein the deployment descriptor comprises at least one of deployment-related information describing the bundled non-J2EE components, a deployment mechanism, a deployment destination and any combination thereof.

22. The method of claim 21, wherein the deployment-related information describing the deployment mechanism specifies at least one instruction that is suitable to cause at least one of downloading and/or deploying the bundled non-J2EE components.

23. A computer readable medium containing a program which, when executed, performs an operation for packaging enterprise information system resources using a Java archive file, the operation comprising:
bundling the enterprise information system resources;
creating a deployment descriptor for the bundled enterprise information system resources; and
packaging the bundled enterprise information system resources and the deployment descriptor into the Java archive file.

24. The computer readable medium of claim 23, wherein the operation further comprises:
enabling download and/or deployment of the Java archive file.

25. The computer readable medium of claim 23, wherein each enterprise information system resource is a platform-dependent non-J2EE component.

26. The computer readable medium of claim 23, wherein each enterprise information system resource is at least one of a database file, a core business application and any combination thereof.

27. The computer readable medium of claim 23, wherein the Java archive file is an enterprise archive file or a web archive file.

28. The computer readable medium of claim 23, wherein bundling the enterprise information system resources comprises:
compressing the enterprise information system resources into one or more compressed files.

29. The computer readable medium of claim 23, wherein the deployment descriptor comprises at least one of deployment-related information describing the bundled enterprise information system resources, a deployment mechanism, a deployment destination and any combination thereof.

30. The computer readable medium of claim 29, wherein the deployment-related information describing the deployment mechanism specifies at least one instruction that is suitable to cause at least one of downloading and/or deploying the bundled enterprise information system resources.

31. The computer readable medium of claim 23, wherein packaging the bundled enterprise information system resources and the deployment descriptor comprises:
creating the Java archive file; and
storing the bundled enterprise information system resources and the deployment descriptor to the created Java archive file.

32. A computer readable medium containing a program which, when executed, performs an operation for deploying enterprise information system resources using a Java archive file, the operation comprising:
compressing the enterprise information system resources into one or more compressed files;
determining deployment-related information describing at least the one or more compressed files, a deployment mechanism and a deployment destination indication;
creating a deployment description file on the basis of the deployment-related information;
packaging the one or more compressed files and the deployment description file into the Java archive file; and
deploying the Java archive file using the deployment-related information.

33. The computer readable medium of claim 32, wherein deploying the Java archive file comprises downloading the Java archive file.

34. The computer readable medium of claim 32, wherein each enterprise information system resource is one of a database file and a core business application.

35. The computer readable medium of claim 32, wherein the Java archive file is an enterprise archive file or a web archive file.

36. The computer readable medium of claim 32, wherein each compressed file is in one of the ZIP, JAR and SAVF file format.

37. The computer readable medium of claim 32, wherein the deployment description file is an XML file.

38. The computer readable medium of claim 32, wherein the deployment-related information describing the deploying mechanism specifies at least one instruction that is suitable to cause at least one of downloading and/or deploying the one or more compressed files, the at least one instruction being one of an FTP, EXTRACT, UNZIP and STRQSH command.

39. The computer readable medium of claim 32, wherein packaging the one or more compressed files and the deployment description file comprises:
creating the Java archive file; and
storing the one or more compressed files and the deployment description file to the created Java archive file.

40. The computer readable medium of claim 39, wherein storing the one or more compressed files and the deployment description file to the created Java archive file is performed using an application assembly tool or a J2EE integrated development environment.

41. A data structure residing in a computer readable medium and comprising:
bundled enterprise information system resources; and
a deployment descriptor for the bundled enterprise information system resources.

42. The data structure of claim 41, wherein the enterprise information system resources are bundled into one or more compressed files.

43. The data structure of claim 41, wherein the bundled enterprise information system resources and the deployment descriptor are packaged into a Java archive file.
